(19) United States
(12) Patent Application Publication
(10) Pub. No.: US 2003/0035702 A1
(43) Pub. Date: Feb. 20, 2003

(54) Screw feed belt assembly

(76) Inventor: Chao Wei Lin, Tainan City (TW)

Correspondence Address: LADAS & PARRY, 26 West 61st Street, New York, NY, 10023-7604, US

(21) Appl. No.: 09/929,887

(22) Filed: Aug. 15, 2001

(51) Int. Cl. F16B 15/08

(52) U.S. Cl. 411/442

(57) ABSTRACT

A screw feed belt assembly includes multiple screws, multiple washers and a belt body. Each of the screws has a head portion on one end of a shank portion. Each of the washers is sleeved on the shank portion of a respective one of the screws and has a diameter not greater than that of the head portion. The belt body includes an elongated back strap, and at least one strip attached to the back strap and cooperating with the back strap so as to confine multiple spaced-apart positioning holes. The shank portion of each of the screws is inserted into a corresponding one of the positioning holes such that the screws are retained on the belt body and such that each of the washers is disposed between the head portion of the respective one of the screws and the strip of the belt body.

### BACKGROUND OF THE INVENTION

1. Field of the Invention

The invention relates to a screw feed belt assembly, more particularly to a screw feed belt assembly that includes a washer disposed between a head portion of a screw and a screw-retaining strip on a belt body.

2. Description of the Related Art

FIGS. 1 and 2 illustrate a conventional screw feed belt assembly that includes a plurality of screws 3, a belt body 1, and a plurality of washers 30. Each of the screws 3 has a shank portion 32 and a head portion 31 on one end of the shank portion 32. The head portion 31 has a diameter (d2). The belt body 1, which is made of plastic, includes an elongated back strap 10, and a pair of parallel strips 11 attached to the back strap 10 and cooperating with the back strap 10 so as to confine a plurality of positioning holes 12 that are spaced apart from each other in a longitudinal direction of the back strap 10 (see FIG. 2). The shank portion 32 of each of the screws 3 is inserted into a corresponding one of the positioning holes 12 such that the screws 3 are retained on the belt body 1. Each of the washers 30 is sleeved on the shank portion 32 of a respective one of the screws 3 such that each washer 30 is disposed between the strips 11 of the belt body 1 and the tip of the respective screw 3, and has a diameter (d1) that is greater than the diameter (d2) of the head portion 31.

FIG. 3 illustrates a screw driving gun 2 that can be used to drive the screws 3 of the conventional screw feed belt assembly. The screw driving gun 2 includes a tubular slider 20 that has a belt receiving groove 22, as shown in FIG. 4. The belt receiving groove 22 has a width (d3) slightly greater than the diameter (d2) of the head portion 31. During the driving operation of one of the screws 3, when the axis of said one of the screws 3 deviates from a normal position, the washer 30 sleeved thereon may abut against that on an adjacent screw 3 such that the orderly arrangement of the screws 3 on the belt body 1 can hardly be maintained and such that the washer 30 on the adjacent screw 3 may slip from the same.

### SUMMARY OF THE INVENTION

Therefore, the object of the present invention is to provide a screw feed belt assembly that facilitates the screw driving operation, and that is clear of the aforesaid drawback associated with the prior art.

According to the present invention, a screw feed belt assembly comprises:

a plurality of screws, each of which has a shank portion and a head portion on one end of the shank portion, the head portion having a first diameter;

a plurality of washers, each of which is sleeved on the shank portion of a respective one of the screws and has a second diameter not greater than the first diameter; and

a belt body including an elongated back strap that has a front surface, and at least one strip attached to the front surface of the back strap and cooperating with the back strap so as to confine a plurality of positioning holes that are spaced apart from each other in a longitudinal direction of the back strap, the shank portion of each of the screws being inserted into a corresponding one of the positioning holes such that the screws are retained on the belt body and such that each of the washers is disposed between the head portion of the respective one of the screws and said at least one strip of the belt body.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary, schematic partly sectional, front view showing a conventional screw feed belt assembly;

FIG. 2 is a fragmentary, schematic sectional view of the conventional screw feed belt assembly taken along line II-II in FIG. 1;

FIG. 3 is a schematic side view illustrating a screw driving gun for use with the conventional screw feed belt assembly;

FIG. 4 is a schematic sectional view of the screw driving gun taken along line IV-IV in FIG. 3;

FIG. 5 is a fragmentary, schematic partly sectional, front view showing the first preferred embodiment of a screw feed belt assembly according to this invention;

FIG. 6 is a fragmentary, schematic sectional view of the first preferred embodiment taken along line VI-VI in FIG. 5;

FIG. 7 is a fragmentary, schematic top view showing the first preferred embodiment;

FIGS. 8a to 8e are schematic views showing different configurations of a head portion of a screw of the first preferred embodiment;

FIG. 9 is a fragmentary, schematic partly sectional, front view showing the second preferred embodiment of a screw feed belt assembly according to this invention; and

FIG. 10 is a fragmentary, schematic top view showing the second preferred embodiment.

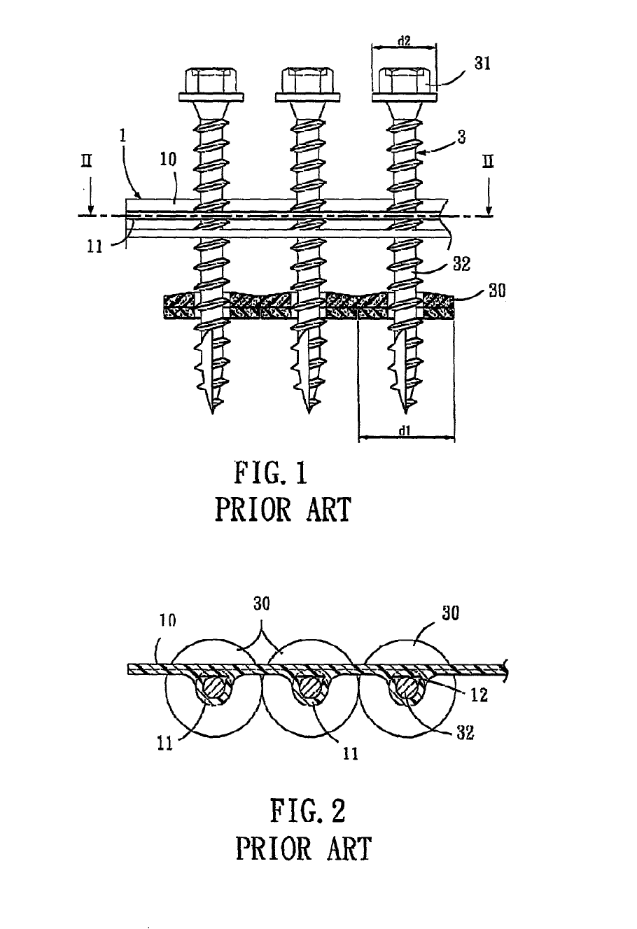

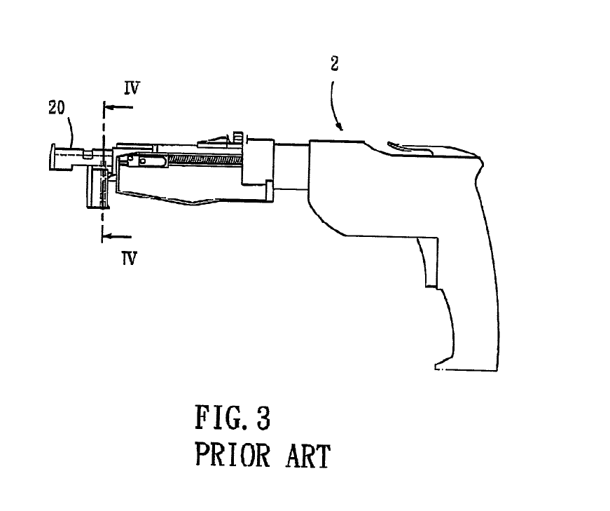

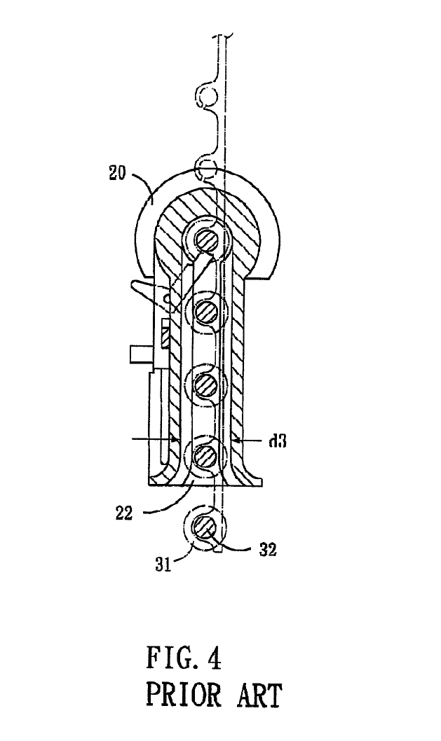

### DETAILED DESCRIPTION OF THE PREFERRED EMBODIMENTS

Before the present invention is described in greater detail, it should be noted that like elements are denoted by the same reference numerals throughout the disclosure.

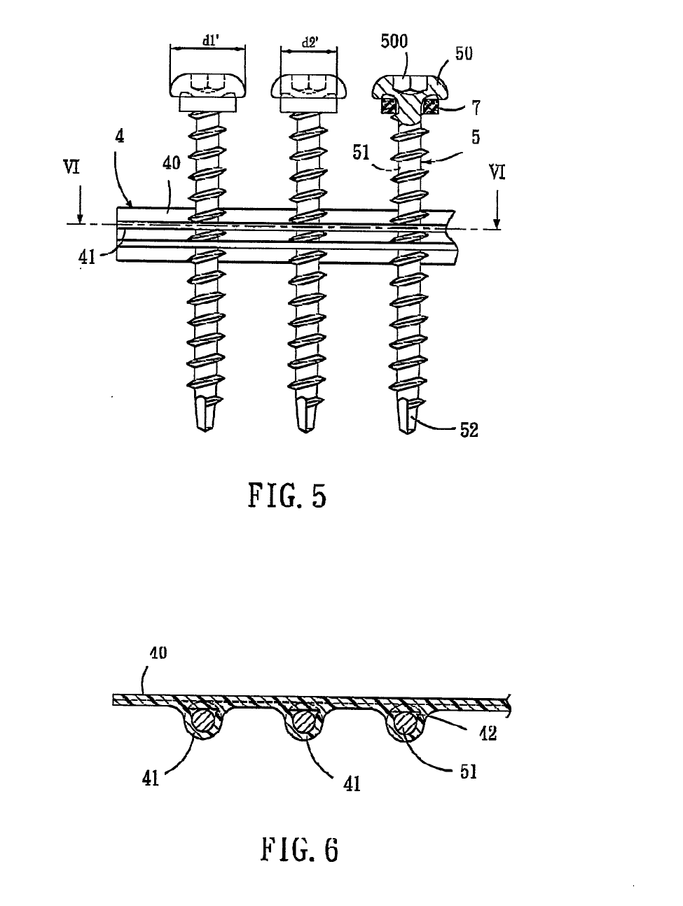

Referring to FIGS. 5 to 7, according to the first preferred embodiment of the present invention, a screw feed belt assembly is shown to include a plurality of screws 5, a plurality of washers 7, and a belt body 4.

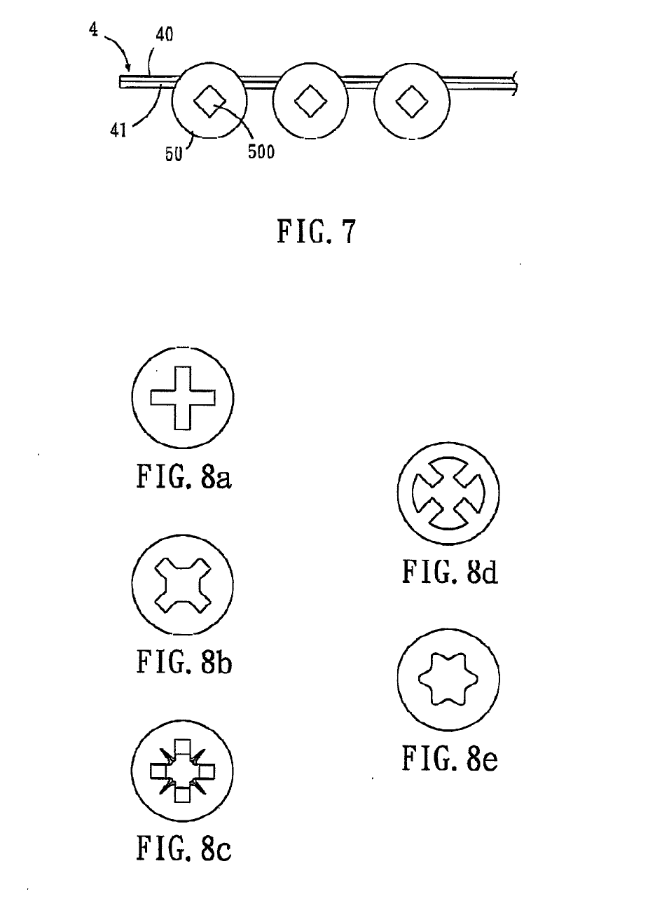

Each of the screws 5 has a shank portion 51 and a head portion 50 on one end of the shank portion 51. In this embodiment, the shank portion 51 has a fluted tip 52 opposite to the head portion 50. The head portion 50 has a first diameter (d1′), and a top surface formed with a square engaging groove 500 (see FIG. 7) that is adapted to engage a screw driving tool (not shown). The engaging grooves on the head portion 50 can have other different configurations, as shown in FIGS. 8a to 8e.

Each of the washers 7 is sleeved on the shank portion 51 of a respective one of the screws 5, and has a second diameter (d2′) that is smaller than the first diameter (d1′).

The belt body 4, which is made of plastic, includes an elongated back strap 40 that has a front surface, and a pair of parallel strips 41 attached to the front surface of the back strap 40 and cooperating with the back strap 40 so as to confine a plurality of positioning holes 42 that are spaced apart from each other in a longitudinal direction of the back strap 40, as shown in FIG. 6. The shank portion 51 of each of the screws 5 is inserted into a corresponding one of the positioning holes 42 such that each of the washers 7 is disposed between the head portion 50 of the respective one of the screws 5 and the strips 41 of the belt body 4.

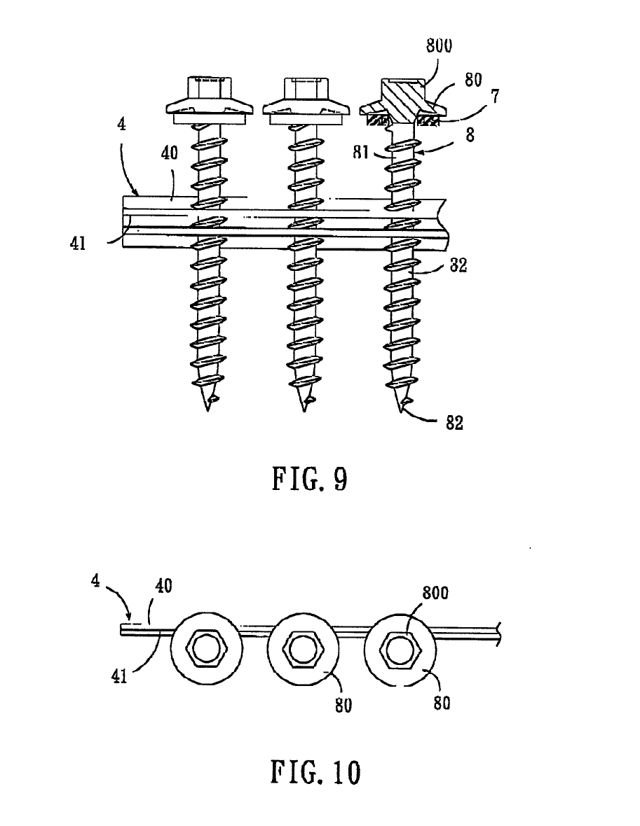

FIGS. 9 and 10 illustrate the second preferred embodiment of a screw feed belt assembly according to the present invention, which is a modification of the first preferred embodiment. Unlike the previous embodiment, the head portion 80 has a hexagonal tool-engaging protrusion 800 formed thereon. The shank portion 81 has a self-tapping tip 82 opposite to the head portion 80.

Since the washers 7 are disposed between the head portions 50, 80 and the belt body 4, and since the diameter (d2′) of the washers 7 is smaller than the diameter (d1′) of the head portions 50, 80, the screw feed belt assembly of this invention can facilitate the screw driving operation. The object of the invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A screw feed belt assembly, comprising:
a plurality of screws, each of which has a shank portion and a head portion on one end of said shank portion, said head portion having a first diameter;
a plurality of washers, each of which is sleeved on said shank portion of a respective one of said screws and has a second diameter not greater than the first diameter; and
a belt body including an elongated back strap that has a front surface, and at least one strip attached to said front surface of said back strap and cooperating with said back strap so as to confine a plurality of positioning holes that are spaced apart from each other in a longitudinal direction of said back strap, said shank portion of each of said screws being inserted into a corresponding one of said positioning holes such that said screws are retained on said belt body and such that each of said washers is disposed between said head portion of the respective one of said screws and said at least one strip of said belt body.
